(19) United States
(12) Patent Application Publication
(10) Pub. No.: US 2019/0118831 A1
(43) Pub. Date: Apr. 25, 2019

(54) VEHICLE CONTROL SYSTEM, VEHICLE CONTROL METHOD, AND VEHICLE CONTROL PROGRAM

(71) Applicant: HONDA MOTOR CO., LTD., Minato-ku, Tokyo (JP)

(72) Inventors: Yoshitaka Mimura, Wako-shi (JP); Kohei Okimoto, Wako-shi (JP); Naotaka Kumakiri, Wako-shi (JP)

(21) Appl. No.: 16/088,520

(22) PCT Filed: Mar. 31, 2016
(86) PCT No.: PCT/JP2016/060863

§ 371 Date: Sep. 26, 2018

(51) Int. Cl. B60W 50/14; G05D 1/00; B60W 10/04; B60W 10/20; B60W 30/18

(52) U.S. Cl. CPC B60W 50/14; G05D 1/0088; B60W 10/04; B60W 10/20; B60W 30/18163; G05D 2201/0213; B60W 2720/106; B60W 2520/10; B60W 2510/20; B60W 2540/10; B60W 2540/12; B60W 2710/20; B60W 2050/146

(57) ABSTRACT

A vehicle control system includes an operation reception unit configured to receive an operation of an occupant of a vehicle, an automated driving control unit configured to automatically perform at least one of speed control and steering control of the vehicle and switch from automated driving to manual driving on the basis of the operation received by the operation reception unit, an output unit configured to output information, and an interface control unit configured to cause the output unit to output information indicating a relationship between an operation amount related to the speed control or the steering control from the occupant of the vehicle received by the operation reception unit and a threshold value of an operation amount at which control for switching from the automated driving to the manual driving is implemented by the automated driving control unit.

### TECHNICAL FIELD

The present invention relates to a vehicle control system, a vehicle control method, and a vehicle control program.

### BACKGROUND ART

In recent years, research on a technique (hereinafter, referred to as automated driving) for automatically performing at least one of speed control and steering control of a subject vehicle has progressed. In relation to this, an automated driving control device that has an override detection device for detecting a steering override that is a steering operation of a driver performed at the time of switching a driving mode and controls the driving mode of a traveling vehicle on the basis of a detection result of the override detection device is known (for example, refer to Patent Literature 1).

### CITATION LIST

### Patent Literature

### [Patent Literature 1]

Japanese Unexamined Patent Application, First Publication No. 2000-276690

### SUMMARY OF INVENTION

### Technical Problem

However, in the related art, since information on a degree of an operation on a driving operation system before the driving mode is switched from automated driving to manual driving by the override is not notified, there is a case where it was not possible to give a sense of security to the vehicle occupant.

The present invention has been made in consideration of such circumstances, and an object of the present invention is to provide a vehicle control system, a vehicle control method, and a vehicle control program capable of giving a sense of security to a vehicle occupant.

### Solution to Problem

According to the invention of claim 1, a vehicle control system (100) includes an operation reception unit (70) configured to receive an operation of an occupant of a vehicle, an automated driving control unit (120) configured to automatically perform at least one of speed control and steering control of the vehicle and switch from automated driving to manual driving on the basis of the operation received by the operation reception unit, an output unit (70) configured to output information, and an interface control unit (174) configured to cause the output unit to output information indicating a relationship between an operation amount related to the speed control or the steering control from the occupant of the vehicle received by the operation reception unit and a threshold value of an operation amount at which control for switching from the automated driving to the manual driving is implemented by the automated driving control unit.

According to the invention of claim 2, in the vehicle control system of claim 1, the interface control unit causes the output unit to output information indicating a result of a comparison between the operation amount and the threshold value.

According to the invention of claim 3, in the vehicle control system of claim 1, in a case where a difference obtained by subtracting the operation amount from the threshold value is within a predetermined value, the interface control unit causes the output unit to output predetermined information.

According to the invention of claim 4, in the vehicle control system of claim 1, the interface control unit causes the output unit to output the threshold value of the operation amount at which the control for switching from the automated driving to the manual driving of the vehicle is implemented.

According to the invention of claim 5, in the vehicle control system of claim 1, the automated driving control unit performs the automated driving in a plurality of modes having different degrees of the automated driving, the output unit includes a plurality of output devices, and the interface control unit selects an output device that outputs the information according to the mode.

According to the invention of claim 6, in the vehicle control system of claim 1, the operation reception unit is at least one of respective operation elements of an accelerator pedal, a brake pedal, and a steering wheel of the vehicle.

According to the invention of claim 7, a vehicle control method that causes an in-vehicle computer to receive an operation of an occupant of a vehicle by an operation reception unit, automatically perform at least one of speed control and steering control of the vehicle and switch from automated driving to manual driving on the basis of the operation received by the operation reception unit, and cause an output unit to output information indicating a relationship between an operation amount related to the speed control or the steering control from the occupant of the vehicle received by the operation reception unit and a threshold value of an operation amount at which control for switching from the automated driving to the manual driving is implemented.

According to the invention of claim 8, a vehicle control program that causes an in-vehicle computer to receive an operation of an occupant of a vehicle by an operation reception unit, automatically perform at least one of speed control and steering control of the vehicle and switch from automated driving to manual driving on the basis of the operation received by the operation reception unit, and cause an output unit to output information indicating a relationship between an operation amount related to the speed control or the steering control from the occupant of the vehicle received by the operation reception unit and a threshold value of an operation amount at which control for switching from the automated driving to the manual driving is implemented.

### Advantageous Effects of Invention

According to the invention of claims 1, 2, 7 and 8, it is possible to give a sense of security for the automated driving to the vehicle occupant.

According to the invention of claim 3, the vehicle occupant can grasp that the operation amount is approaching the threshold value in advance before the operation amount exceeds the threshold value.

According to the invention of claim 4, the vehicle occupant can more clearly grasp a difference from a current operation situation with respect to an HMI 70, by outputting the threshold value of the operation amount from the output unit.

According to the invention of claim 5, it is possible to display the information on the output device with a high possibility that the vehicle occupant is watching according to the mode. Therefore, the vehicle occupant can more clearly grasp the displayed information.

According to the invention of claim 6, it is possible to display the result of the comparison with each threshold value in correspondence with operation contents to the respective operation elements of the accelerator pedal, the brake pedal, and the steering wheel.

### BRIEF DESCRIPTION OF DRAWINGS

FIG. 1 is a diagram illustrating a constitution element of a vehicle on which a vehicle control system 100 of an embodiment is mounted.

FIG. 2 is a functional constitution diagram centered on the vehicle control system 100 according to the embodiment.

FIG. 3 is a constitution diagram of an HMI 70.

FIG. 4 is a diagram illustrating a functional constitution example of a traveling driving force output device 200.

FIG. 5 is a diagram illustrating a functional constitution example of a steering device 210.

FIG. 6 is a diagram illustrating a functional constitution example of a brake device 220.

FIG. 7 is a diagram illustrating an aspect in which a relative position of a subject vehicle M with respect to a traveling lane L1 is recognized by a subject vehicle position recognition unit 140.

FIG. 8 is a diagram illustrating an example of an action plan generated for a certain section.

FIG. 9 is a diagram illustrating an example of a constitution of a trajectory generation unit 146.

FIG. 10 is a diagram illustrating an example of a candidate for a trajectory generated by a trajectory candidate generation unit 146B.

FIG. 11 is a diagram expressing the candidate for the trajectory generated by the trajectory candidate generation unit 146B by the trajectory point K.

FIG. 12 is a diagram illustrating a lane change target position TA.

FIG. 13 is a diagram illustrating a speed generation model in a case where it is assumed that speeds of three surroundings vehicles are constant.

FIG. 14 is a diagram illustrating an example of an override threshold value 188.

FIG. 15 is a diagram illustrating a functional constitution example of an HMI control unit 170.

FIG. 16 is a diagram illustrating an example of mode-specific operation permission or prohibition information 190.

FIG. 17 is a diagram illustrating a first example in which information indicating a relationship between an operation amount and a threshold value is output.

FIG. 18 is a diagram illustrating a second example in which the information indicating the relationship between the operation amount and the threshold value is output.

FIG. 19 is a diagram for explaining an operation content of a vehicle occupant in the subject vehicle M.

FIG. 20 is a flowchart illustrating an example of a switch control processing.

FIG. 21 is a flowchart illustrating an example of a display control processing.

### DESCRIPTION OF EMBODIMENTS

Hereinafter, embodiments of a vehicle control system, a vehicle control method, and a vehicle control program of the present invention will be described with reference to the drawings.

<Common Constitution>

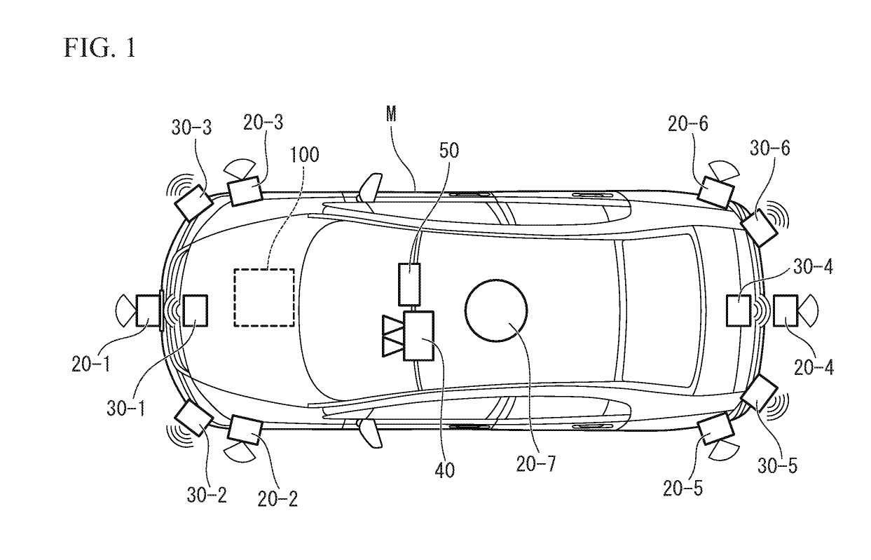

FIG. 1 is a diagram illustrating a constitution element of a vehicle (hereinafter, referred to as a subject vehicle M) on which a vehicle control system 100 of an embodiment is mounted. For example, the vehicle on which the vehicle control system 100 is mounted is a vehicle such as a two-wheeled vehicle, a three-wheeled vehicle, or four-wheeled vehicle, and includes a vehicle using an internal combustion engine such as a diesel engine or a gasoline engine as a power source, an electric vehicle using an electric motor as a power source, a hybrid vehicle including an internal combustion engine and an electric motor, and the like. For example, the electric vehicle is driven using electric power discharged by a battery such as a secondary battery, a hydrogen fuel cell, a metal fuel cell, and an alcohol fuel cell.

As shown in FIG. 1, sensors such as finders 20-1 to 20-7, radars 30-1 to 30-6, a camera 40, a navigation device 50, and the vehicle control system 100 are mounted on the subject vehicle M.

For example, the finders 20-1 to 20-7 are light detection and ranging or laser imaging detection and ranging (LIDAR) finders that measure scattered light with respect to irradiation light and measure a distance to an object. For example, the finder 20-1 may be attached to a front grille or the like, and the finders 20-2 and 20-3 are attached to a side surface of a vehicle body, a door mirror, a headlight inside, in the vicinity of a side lamp, or the like. The finder 20-4 is attached to a trunk lid or the like, and the finders 20-5 and 20-6 are attached to the side surface of the vehicle body, a taillight inside, or the like. For example, the finders 20-1 to 20-6 described above have a detection region of about 150 degrees with respect to a horizontal direction. In addition, the finder 20-7 is attached to a roof or the like. For example, the finder 20-7 has a detection region of 360 degrees with respect to the horizontal direction.

For example, the radars 30-1 and 30-4 are long distance millimeter wave radars of which the detection region in a depth direction is wider than other radars. In addition, the radars 30-2, 30-3, 30-5, and 30-6 are intermediate distance millimeter wave radars of which the detection region in a depth direction is smaller than the radars 30-1 and 30-4.

Hereinafter, the finders 20-1 to 20-7 are simply referred to as “finders 20” in a case where the finders 20-1 to 20-7 are not particularly distinguished from each other, and the radars 30-1 to 30-6 are simply referred to as “radars 30” in a case where the radars 30-1 to 30-6 are not particularly distinguished from each other. For example, the radar 30 detects an object by a frequency modulated continuous wave (FM-CW) method.

For example, the camera 40 is a digital camera using an individual imaging device such as a charge coupled device (CCD) or a complementary metal oxide semiconductor (CMOS). The camera 40 is attached to an upper portion of a front windshield, a rear surface of a rearview mirror, or the like. For example, the camera 40 periodically images in front of the subject vehicle M repeatedly. The camera 40 may be a stereo camera including a plurality of cameras.

It should be noted that the constitution shown in FIG. 1 is merely an example, and a part of the constitution may be omitted or other constituents may be added.

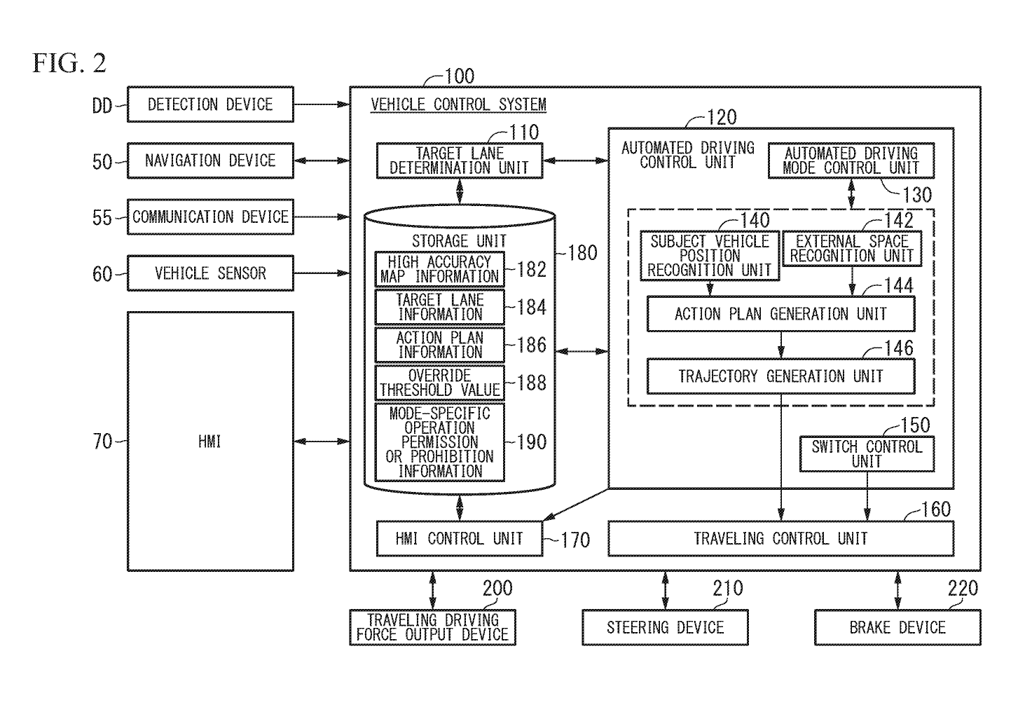

FIG. 2 is a functional constitution diagram centered on the vehicle control system 100 according to the embodiment. A detection device DD including the finder 20, the radar 30, the camera 40, and the like, the navigation device 50, a communication device 55, a vehicle sensor 60, a human machine interface (HMI) 70, the vehicle control system 100, a traveling driving force output device 200, a steering device 210, and a brake device 220 are mounted on the subject vehicle M. Such devices and apparatuses are connected to each other by a multiplex communication line such as a controller area network (CAN) communication line, a serial communication line, a wireless communication network, or the like. It is noted that the vehicle control system in the claims may include not only the “vehicle control system 100” but also constitutions (the detection device DD, the HMI 70, or the like) other than the vehicle control system 100.

The navigation device 50 includes a global navigation satellite system (GNSS) receiver, map information (a navigation map), a touch panel type display device functioning as a user interface, a speaker, a microphone, and the like. The navigation device 50 specifies a position of the subject vehicle M by the GNSS receiver and derives a route from the position to a destination designated by a user. The route derived by the navigation device 50 is provided to a target lane determination unit 110 of the vehicle control system 100. The position of the subject vehicle M may be specified or supplemented by an inertial navigation system (INS) using an output of the vehicle sensor 60. In addition, the navigation device 50 performs guidance by a sound or a navigation display about the route to the destination. It is noted that the constitution for specifying the position of the subject vehicle M may be provided independently from the navigation device 50. In addition, for example, the navigation device 50 may be realized by a function of a terminal device such as a smartphone or a tablet terminal possessed by a vehicle occupant (an occupant) of the subject vehicle M. In this case, transmission and reception of information is performed between the terminal device and the vehicle control system 100 by wireless or wired communication.

For example, the communication device 55 performs wireless communication using a cellular network, a Wi-Fi network, Bluetooth (registered trademark), dedicated short range communication (DSRC), or the like.

The vehicle sensor 60 includes a vehicle speed sensor that detects a vehicle speed, an acceleration sensor that detects acceleration, a yaw rate sensor that detects an angular velocity around a vertical axis, a direction sensor that detects a direction of the subject vehicle M, and the like.

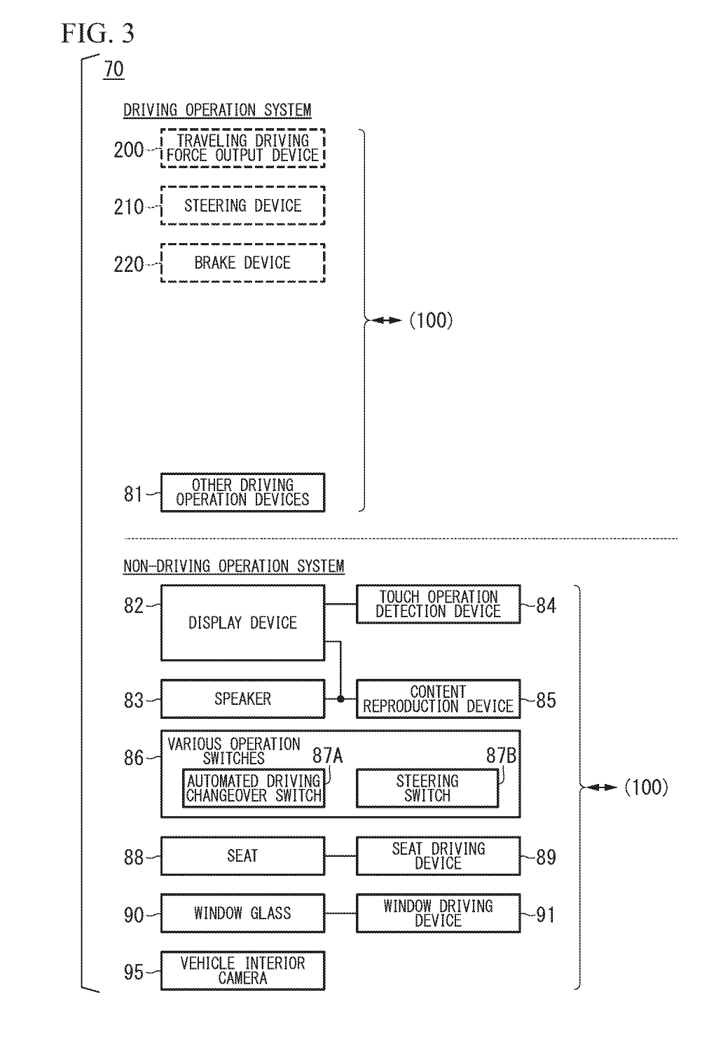

FIG. 3 is a constitution diagram of the HMI 70. For example, the HMI 70 includes a constitution of a driving operation system and a constitution of a non-driving operation system. A boundary between the constitution of the driving operation system and the constitution of the non-driving operation system is not clear, and the constitution of the driving operation system may have a function of the non-driving operation system (or the reverse function thereof may be provided). A part of the HMI 70 is an example of an “operation reception unit” that receives an operation of the vehicle occupant of the subject vehicle M and an example of an “output unit” that outputs information.

For example, as the constitution of the driving operation system, the HMI 70 includes a traveling driving force output device 200, a steering device 210, a brake device 220, and other driving operation devices 81 as shown in FIG. 2.

The traveling driving force output device 200, the steering device 210, and the brake device 220 perform traveling of the vehicle by automated driving or manual driving under control of the vehicle control system 100. It is noted that specific examples of the traveling driving force output device 200, the steering device 210, and the brake device 220 will be described later.

For example, the other driving operation devices 81 are a shift lever and a shift position sensor. The shift lever is an operation element for receiving an instruction to shift a shift stage from the vehicle occupant. The shift position sensor detects the shift stage instructed by the vehicle occupant using the shift lever and outputs a shift position signal indicating a detection result to the vehicle control system 100.

In addition, for example, the other driving operation devices 81 are a joystick, a button, a dial switch, a graphic user interface (GUI) switch, and the like. The other driving operation devices 81 receive the acceleration instruction, the deceleration instruction, the turn instruction, and the like, and output the acceleration instruction, the deceleration instruction, the turn instruction, and the like to the vehicle control system 100.

For example, as a constitution of the non-driving operation system, the HMI 70 includes a display device 82, a speaker 83, a touch operation detection device 84, a content reproduction device 85, various operation switches 86, a seat 88, a seat driving device 89, a window glass 90, a window driving device 91, and a vehicle interior camera 95.

The display device 82 is, for example, an LCD (Liquid Crystal Display), an organic EL (Electro Luminescence) display device, or the like attached to respective parts such as the instrument panel, or arbitrary parts facing an assistant driver's seat, a rear seat, or the like. For example, the display device 82 is a display positioned on the front side of the vehicle occupant who drives the subject vehicle M. For example, the display device 82 may be a head up display (HUD) that projects an image onto a front windshield or other windows. The speaker 83 outputs a sound. In a case where the display device 82 is a touch panel, the touch operation detection device 84 detects a contact position (a touch position) on a display screen of the display device 82 and outputs the touch position to the vehicle control system 100. It is noted that the touch operation detection device 84 may be omitted in a case where the display device 82 is not a touch panel.

The content reproduction device 85 includes, for example, a digital versatile disc (DVD) reproduction device, a compact disc (CD) reproduction device, a television receiver, a reproduction device of various guidance images, and the like. A part or all of the display device 82, the speaker 83, the touch operation detection device 84, and the content reproduction device 85 may be common to the navigation device 50. In addition, the navigation device 50 may be included in the HMI 70.

The various operation switches 86 are disposed at arbitrary positions in an interior of the vehicle. The various operation switches 86 include an automated driving changeover switch 87A for instructing starting (or the future start) and stopping of the automated driving and a steering switch 87B for enabling the vehicle occupant to set a display content and the like on each display unit (for example, the navigation device 50, the display device 82, and the content reproduction device 85) or switch a screen while grasping the steering wheel. The automated driving changeover switch 87A and the steering switch 87B may be any of a graphical user interface (GUI) switch and a mechanical switch. In addition, the various operation switches 86 may include a switch for driving the seat driving device 89 or the window driving device 91. In a case where the various operation switches 86 receive the operation from the vehicle occupant, the various operation switches 86 output an operation signal to the vehicle control system 100.

The seat 88 is a seat on which the vehicle occupant is seated. The seat driving device 89 freely drives a reclining angle, back and forth direction and position, a yaw angle, and the like of the seat 88. For example, the window glass 90 is provided at each door. The window driving device 91 drives the window glass 90 to open and close the window glass 90.

The vehicle interior camera 95 is a digital camera using an individual imaging device such as a CCD or a CMOS. The vehicle interior camera 95 is attached at a position where it is possible to image at least a head of the vehicle occupant who is performing a driving operation, such as a rearview mirror, a steering boss portion, or the instrument panel. For example, the camera 40 repeatedly images the vehicle occupant periodically.

Here, prior to the description of the vehicle control system 100, a specific example of the traveling driving force output device 200, the steering device 210, and the brake device 220 described above will be described.

<Functional Constitution Example of Traveling Driving Force Output Device 200>

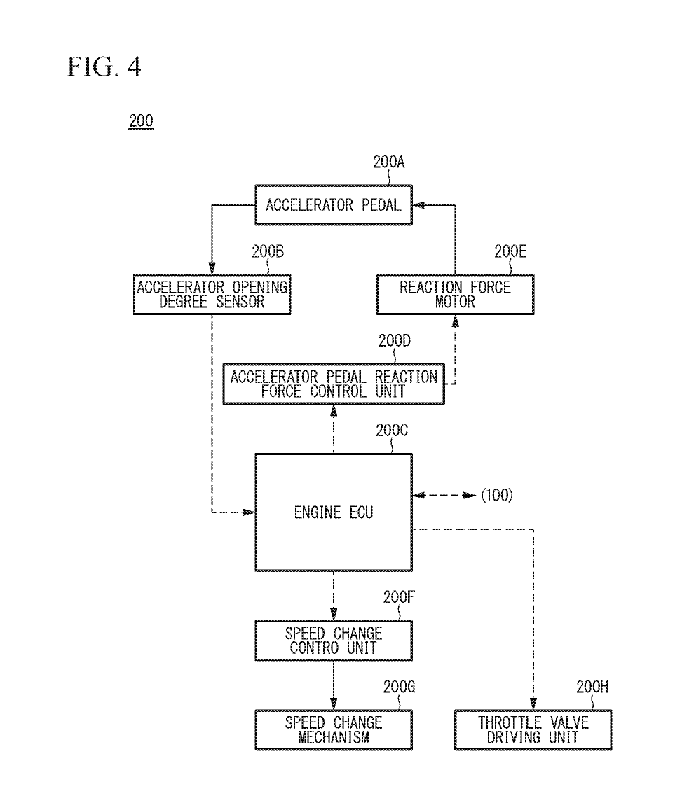

FIG. 4 is a diagram illustrating the functional constitution example of the traveling driving force output device 200. The traveling driving force output device 200 shown in FIG. 4 includes an accelerator pedal 200A, an accelerator opening degree sensor 200B, an engine electronic control unit (ECU) 200C, an accelerator pedal reaction force control unit 200D, a reaction force motor 200E, a speed change control unit 200F, a speed change mechanism 200G, and a throttle valve driving unit 200H, but is not limited thereto. A combination of the accelerator pedal reaction force control unit 200D and the reaction force motor 200E is an example of an accelerator pedal reaction force output device.

The accelerator pedal 200A is an operation element for receiving an acceleration instruction (or a deceleration instruction by a return operation) by the vehicle occupant of the subject vehicle M. The accelerator opening degree sensor 200B detects the depression amount of the accelerator pedal 200A and outputs an accelerator opening degree signal indicating the depression amount.

Here, for example, in a case where the subject vehicle M is a vehicle powered by an internal combustion engine, the subject vehicle M includes an engine, a transmission, and the engine ECU 200C that controls the engine. In addition, in a case where the subject vehicle M is an electric vehicle powered by an electric motor, the subject vehicle M includes a traveling motor in place of the engine and the transmission described above and includes a motor ECU in place of the engine ECU 200C. In addition, in a case where the subject vehicle M is a hybrid vehicle, the subject vehicle M includes the engine, the transmission, the engine ECU, the traveling motor, and the motor ECU described above.

The engine ECU 200C generates a control signal for adjusting a shift stage or the like in the speed change mechanism 200G or the like according to information input from a traveling control unit 160 that will be described later and outputs the generated control signal to the speed change control unit 200F. In addition, the traveling driving force output device 200 adjusts a throttle opening degree of a throttle valve of the engine and outputs a driving signal to the throttle valve driving unit 200H.

In addition, in a case where the traveling driving force output device 200 includes only the traveling motor, the traveling driving force output device 200 includes the motor ECU in place of the engine ECU 200C described above. In this case, the motor ECU adjusts a duty ratio of a PWM signal to be supplied to the traveling motor according to the information input from the traveling control unit 160. In addition, in a case where the traveling driving force output device 200 includes an engine and a traveling motor, the engine ECU 200C and the motor ECU cooperate with each other to control the traveling driving force according to the information input from the traveling control unit 160.

In addition, the engine ECU 200C outputs a reaction force control signal for outputting a force (a reaction force) of a direction opposite to the force (the depression force) pressing the accelerator pedal 200A to the accelerator pedal 200A in correspondence with the accelerator opening degree signal obtained from the accelerator opening degree sensor 200B to the accelerator pedal reaction force control unit 200D.

The accelerator pedal reaction force control unit 200D generates a driving signal for controlling driving to the reaction force motor 200E for producing the reaction force to the accelerator pedal 200A on the basis of the reaction force control signal from the engine ECU 200C. For example, the accelerator pedal reaction force control unit 200D supplies the reaction force of an arbitrary magnitude to the accelerator pedal 200A according to a stroke amount, a stroke speed, or another signal by a torque generated by the reaction force motor 200E.

The reaction force motor 200E outputs the reaction force in response to the depression force of the vehicle occupant to the accelerator pedal 200A on the basis of the driving signal from the accelerator pedal reaction force control unit 200D.

The speed change control unit 200F transmits speed change information to the speed change mechanism 200G based on a speed change instruction from the engine ECU 200C and performs speed change control. As a result, the speed change mechanism 200G changes the speed of the subject vehicle M.

The throttle valve driving unit 200H opens and closes the throttle valve by the driving signal from the engine ECU 200C and changes the throttle opening degree corresponding to the accelerator opening degree sensor 200B.

It is noted that the above-described engine ECU 200C cooperates with the vehicle control system 100 to perform the various controls described above. The engine ECU 200C may be a computer device separate from the vehicle control system 100 or may be a single computer device integrated with the vehicle control system 100.

<Functional Constitution Example of Steering Device 210>

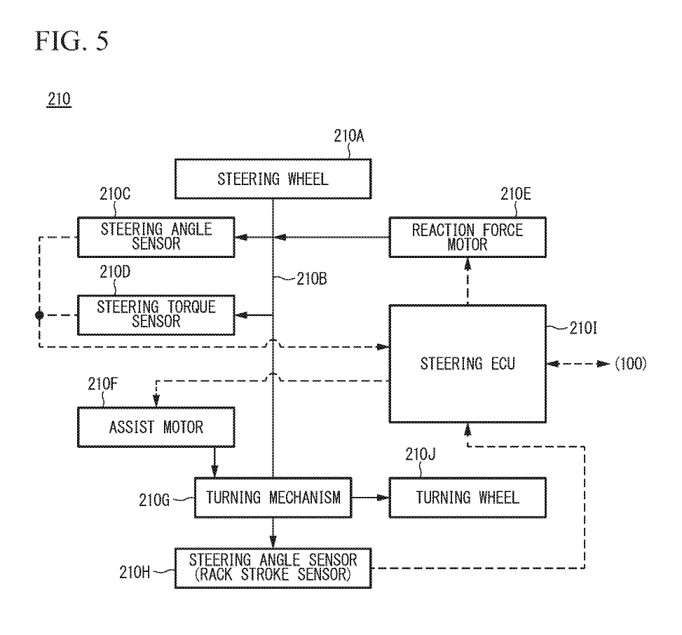

FIG. 5 is a diagram illustrating the functional constitution example of the steering device 210. The steering device 210 includes a steering wheel 210A, a steering shaft 210B, a steering angle sensor 210C, a steering torque sensor 210D, a reaction force motor 210E, an assist motor 210F, a turning mechanism 210G, a steering angle sensor 210H, and a steering ECU 2101, but is not limited thereto.

The steering wheel 210A is an example of an operation element for receiving a steering instruction by the vehicle occupant. Instead of the steering wheel 210A, another type of operation device such as a joystick may be mounted. An operation performed on the steering wheel 210A is transferred to the steering shaft 210B. The steering angle sensor 210C and the steering torque sensor 210D are attached to the steering shaft 210B. The steering angle sensor 210C detects an angle at which the steering wheel 210A is operated and outputs the angle to the steering ECU 2101. The steering torque sensor 210D detects a torque (a steering torque) acting on the steering shaft 210B and outputs the torque to the steering ECU 2101. The reaction force motor 210E outputs the torque to the steering shaft 210B under control of the steering ECU 2101 to output an operation reaction force to the steering wheel 210A.

The assist motor 210F outputs the torque to the turning mechanism 210G under the control of the steering ECU 2101 to generate a steering force to the turning mechanism 210G. For example, the turning mechanism 210G is a rack and pinion mechanism. The steering angle sensor 210H detects an amount (for example, a rack stroke) indicating the angle (the steering angle) of the turning mechanism 210G and outputs the amount to the steering ECU 2101. The steering shaft 210B and the turning mechanism 210G may be fixedly connected with each other, disconnected from each other, or connected with each other through a clutch mechanism or the like.

The steering ECU 2101 cooperates with the vehicle control system 100 to perform the various controls described above. The steering ECU 2101 may be a computer device separated from the vehicle control system 100 or may be a single computer device integrated with the vehicle control system 100.

<Functional Constitution Example of Brake Device 220>

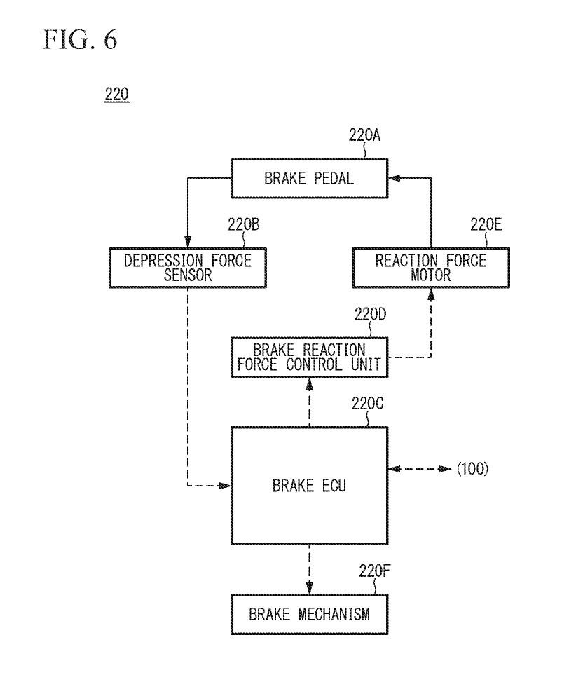

FIG. 6 is a diagram illustrating the functional constitution example of the brake device 220. The brake device 220 shown in FIG. 6 includes a brake pedal 220A, a depression force sensor 220B, a brake ECU 220C, a brake reaction force control unit 220D, a reaction force motor 220E, and a brake mechanism 220F, but is not limited thereto.

The brake pedal 220A is an operation element for receiving a deceleration instruction by the vehicle occupant. The depression force sensor 220B detects the depression force (or the depression amount) applied to the brake pedal 220A and outputs a brake signal indicating a detection result to the brake ECU 220C.

The brake ECU 220C generates a control signal for controlling an operation of the reaction force motor 220E on the basis of the depression force of the brake pedal 220A detected by the depression force sensor 220B or the like. In addition, the brake ECU 220C controls an operation of the brake mechanism 220F such as a brake actuator on the basis of the depression force of the brake pedal 220A detected by the depression force sensor 220B or the like.

The brake reaction force control unit 220D controls the reaction force output to the brake pedal 220A through the reaction force motor 220E on the basis of the control signal from the brake ECU 200C.

The reaction force motor 220E generates a torque under the control of the brake reaction force control unit 220D and outputs the reaction force of an arbitrary magnitude according to the stroke amount, the stroke speed, or another signal to the brake pedal 220A according to the generated torque. It is noted that the reaction force motor 220E has a function of generating the reaction force against the operation of the brake pedal 220A and a function of changing a stroke start depression force of the brake pedal 220A.

It is noted that the above-described brake ECU 220C cooperates with the vehicle control system 100 to perform the various controls described above. The brake ECU 220C may be a computer device separated from the vehicle control system 100 or may be a single computer device integrated with the vehicle control system 100.

The traveling driving force output device 200, the steering device 210, and the brake device 220 described above are able to give the reaction forces to the accelerator pedal 200A, the steering wheel 210A, and the brake pedal 220A, respectively. For example, these reaction forces are able to give a reaction force so that the vehicle occupant of the subject vehicle M does not perform an erroneous override. Therefore, for example, the accelerator pedal 200A and the brake pedal 220A are able to be used as a footrest (a place where a foot is put) during the automated driving or the steering wheel 210A is able to be used as an armrest (a place where an arm is put).

[Vehicle Control System]

Hereinafter, the vehicle control system 100 will be described. For example, the vehicle control system 100 is realized by one or more processors or hardware having an equivalent function. The vehicle control system 100 may have a constitution in which an electronic control unit (ECU) in which a processor such as a central processing unit (CPU), a storage device, and a communication interface are connected with each other by an internal bus, a micro-processing unit (MPU), or the like is combined.

Returning to FIG. 2, for example, the vehicle control system 100 includes the target lane determination unit 110, an automated driving control unit 120, the traveling control unit 160, an HMI control unit (an interface control unit) 170, and a storage unit 180. For example, the automated driving control unit 120 includes an automated driving mode control unit 130, a subject vehicle position recognition unit 140, an external space recognition unit 142, an action plan generation unit 144, a trajectory generation unit 146, and the switch control unit 150.

The target lane determination unit 110, each unit of the automated driving control unit 120, and a part or all of the traveling control unit 160 are realized by a processor executing a program (software). In addition, a part or all of these may be realized by hardware such as a large scale integration (LSI) or an application specific integrated circuit (ASIC) or may be realized by a combination of software and hardware.

For example, the storage unit 180 stores information such as high accuracy map information 182, target lane information 184, action plan information 186, an override threshold value 188, and mode-specific operation permission or prohibition information 190. The storage unit 180 is realized by a read only memory (ROM), a random access memory (RAM), a hard disk drive (HDD), a flash memory, or the like. The program executed by the processor may be stored in the storage unit 180 in advance or may be downloaded from an external device through an in-vehicle Internet facility or the like. In addition, the program may be installed in the storage unit 180 when a portable storage medium storing the program is mounted in a drive device that is not shown. In addition, a computer (an in-vehicle computer) of the vehicle control system 100 may be distributed by a plurality of computer devices.

For example, the target lane determination unit 110 is realized by the MPU. The target lane determination unit 110 divides the route provided from the navigation device 50 into a plurality of blocks (for example, divides the route every 100 [m] with respect to the vehicle traveling direction) and determines a target lane for each block with reference to the high accuracy map information 182. For example, the target lane determination unit 110 determines which number of lane a certain number spaced apart from the left the vehicle travels on. For example, in a case where a branching position, a merging position, or the like is present on the route, the target lane determination unit 110 determines the target lane so that the subject vehicle M may travel on a reasonable traveling route for progressing to a branch destination. The target lane determined by the target lane determination unit 110 is stored in the storage unit 180 as the target lane information 184.

The high accuracy map information 182 is map information with accuracy higher than a navigation map included in the navigation device 50. For example, the high accuracy map information 182 includes on the center of a lane or information on a boundary of a lane. In addition, the high accuracy map information 182 may include road information, traffic regulations information, address information (an address and a postal code), facility information, telephone number information, and the like. The road information includes information indicating a type of a road such as an expressway, a toll road, a national highway, a prefectural road, or information on the number of lanes on the road, the width of each lane, a gradient of the road, the position of the road (three-dimensional coordinates including the longitude, the latitude, and the height), the curvature of a curve of a lane, the positions of junction and branch points of a lane, a sign provided on the road, and the like. The traffic regulations information includes information that lanes are blocked due to a construction, a traffic accident, traffic congestion, or the like.

The automated driving control unit 120 automatically controls at least one of speed control and steering control of the subject vehicle M. In addition, for example, the speed control is control related to acceleration or deceleration of the subject vehicle M and the acceleration or deceleration includes one or both of acceleration and deceleration. In addition, the automated driving control unit 120 performs control for automatically switching from the automated driving to the manual driving on the basis of the operation received by an operation reception unit such as the HMI 70.

The automated driving mode control unit 130 determines a mode of the automated driving executed by the automated driving control unit 120. The mode of the automated driving in the present embodiment includes the following plurality of different modes. It is noted that the following are merely examples, and the number of the mode of the automated driving or contents of each mode may be arbitrary determined.

[Mode A]

The mode A is a mode of which a degree of the automated driving is the highest. In a case where the mode A is being executed, all vehicle controls such as complicated merging control are automatically performed, the vehicle occupant does not need to monitor surroundings or state of the subject vehicle M.

[Mode B]

The mode B is a mode of which a degree of the automated driving is high next to the mode A. In a case where the mode B is being executed, in principle, all vehicle controls are automatically performed, but the driving operation of the subject vehicle M is entrusted to the vehicle occupant according to a situation. Therefore, the vehicle occupant needs to monitor the surroundings or state of the subject vehicle M.

[Mode C]

The mode C is a mode of which a degree of the automated driving is high next to the mode B. In a case where the mode C is being executed, the vehicle occupant needs to perform a confirmation operation on the HMI 70 according to the situation. For example, in the mode C, in a case where a timing of a lane change is notified to the vehicle occupant and the vehicle occupant performs an operation for instructing the HMI 70 to change the lane, an automated lane change is performed. Therefore, the vehicle occupant needs to monitor the surroundings or state of the subject vehicle M.

The automated driving mode control unit 130 determines the mode of the automated driving on the basis of the operation of the vehicle occupant with respect to the HMI 70, an event determined by the action plan generation unit 144, a traveling aspect determined by the trajectory generation unit 146, and the like. The mode of the automated driving is notified to the HMI control unit 170. In addition, a limit according to performance or the like of the detection device DD of the subject vehicle M may be set in the mode of the automated driving. For example, in a case where the performance of the detection device DD is low, the mode A may not be performed. In any mode, it is possible to switch (override) to the manual driving mode by an operation for a constitution of a driving operation system in the HMI 70.

The subject vehicle position recognition unit 140 recognizes a lane (a traveling lane) on which the subject vehicle M is traveling and a relative position of the subject vehicle M with respect to the traveling lane on the basis of the high accuracy map information 182 stored in the storage unit 180, and the information input from the finder 20, the radar 30, the camera 40, the navigation device 50, or the vehicle sensor 60.

For example, the subject vehicle position recognition unit 140 may recognize the traveling lane by comparing a pattern of road lane line (for example, an arrangement of solid lines and broken lines) recognized from the high accuracy map information 182 with a pattern of a road lane line of the surroundings of the subject vehicle M recognized from the image captured by the camera 40. In the recognition, the position of the subject vehicle M acquired from the navigation device 50 or the process result by the INS may be included.

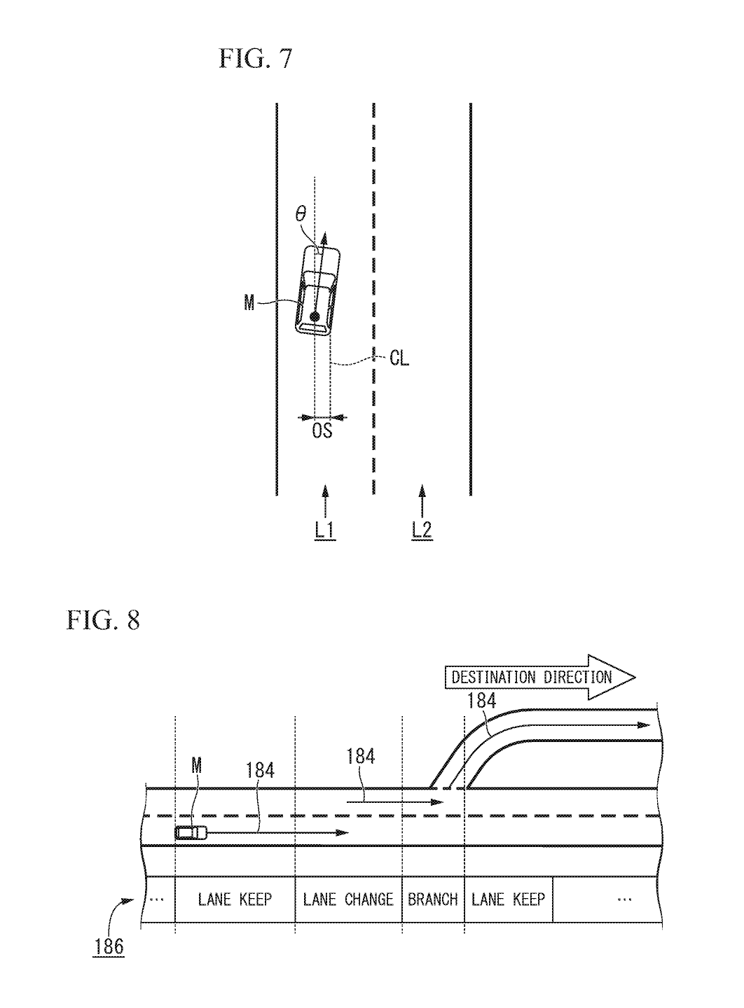

FIG. 7 is a diagram illustrating an aspect in which the relative position of the subject vehicle M with respect to a traveling lane L1 is recognized by the subject vehicle position recognition unit 140. For example, the subject vehicle position recognition unit 140 recognizes a deviation OS from a traveling lane center CL of a reference point (for example, a center of gravity) of the subject vehicle M and an angle θ formed with respect to a line connecting the traveling lane center CL of a direction of travel of the subject vehicle M, as the relative position of the subject vehicle M with respect to the traveling lane L1. In addition, instead of this, the subject vehicle position recognition unit 140 may recognize the position or the like of the reference point of the subject vehicle M with respect to one of side ends of the subject lane L1 as the relative position of the subject vehicle M with respect to the traveling lane. The relative position of the subject vehicle M recognized by the subject vehicle position recognition unit 140 is provided to target lane determination unit 110.

The external space recognition unit 142 recognizes a state such as the position, the speed, and the acceleration of a surroundings vehicle, on the basis of the information input from the finder 20, the radar 30, the camera 40, and the like. For example, the surrounding vehicle is a vehicle traveling around the subject vehicle M and traveling in the same direction as the subject vehicle M. The position of the surrounding vehicle may be indicated by a representative point such as a center of gravity or a corner of the surroundings vehicle or may be indicated by a region expressed by an outline of another vehicle. The “state” of the surroundings vehicle may include an acceleration of the surroundings vehicle or whether or not the surroundings vehicle is changing a lane (or whether or not the surroundings vehicle is trying to change the lane) grasped on the basis of the information of the above-described various devices. In addition, the external space recognition unit 142 may recognize positions of a guardrail, a utility pole, a parked vehicle, a pedestrian, a falling object, a crossing, a traffic light, a sign installed in the vicinity of a construction site or the like, and other objects in addition to the surroundings vehicle.

The action plan generation unit 144 sets a start point of the automated driving and/or a destination of the automated driving. The start point of the automated driving may be a current position of the subject vehicle M or may be a point where the operation for instructing the automated driving is performed. The action plan generation unit 144 generates an action plan in a section between the start point and the destination of the automated driving. It is noted that the present invention is not limited thereto, and the action plan generation unit 144 may generate the action plan for an arbitrary section.

For example, the action plan includes a plurality of events that are sequentially executed. For example, the event includes a deceleration event for decelerating the subject vehicle M, an acceleration event for accelerating the subject vehicle M, a lane keep event for causing the subject vehicle M to travel so as not to deviate from the traveling lane, a lane change event for changing the traveling lane, an overtaking event for causing the subject vehicle M to overtake a preceding vehicle, a branch event for changing the subject vehicle M to a desired lane or causing the subject vehicle M to travel so as not to deviate from the current traveling lane at a branch point, a merge event for causing the subject vehicle M to accelerate or decelerate (accelerate or decelerate) and changing the traveling lane in the merge lane for merging the subject vehicle M to a main lane, a handover event for shifting the mode from the manual driving mode to the automated driving mode at the start point of the automated driving or shifting the mode from the automated driving mode to the manual driving mode at the end scheduled point of the automated driving. The action plan generation unit 144 sets the lane change event, the branch event, or the merge event at a place where the target lane determined by the target lane determination unit 110 switches. Information indicating the action plan generated by the action plan generation unit 144 is stored in the storage unit 180 as the action plan information 186.

FIG. 8 is a diagram illustrating an example of the action plan generated for a certain section. As shown in the drawing, the action plan generation unit 144 generates the action plan necessary for the subject vehicle M to travel on the target lane indicated by the target lane information 184. It is noted that the action plan generation unit 144 may dynamically change the action plan regardless of the target lane information 184 according to a situation change of the subject vehicle M. For example, in a case where the speed of the surroundings vehicle recognized by the external space recognition unit 142 during the vehicle traveling is greater than a threshold value or a movement direction of the surroundings vehicle traveling in a lane adjacent to the subject lane faces toward the subject lane, the action plan generation unit 144 changes the event set in a driving section where the subject vehicle M is scheduled to travel. For example, in a case where the event is set so that the lane change event is executed after the lane keep event, the action plan generation unit 144 may change an event next to the lane keep event from the lane keep event to the deceleration event, the lane keep event, or the like in a case where it is determined that a vehicle proceeds at a speed equal to or greater than the threshold value from behind a lane of a lane change destination during the lane keep event by the recognition result of the external space recognition unit 142. As a result, the vehicle control system 100 can cause the subject vehicle M to automatically travel safely even in a case where a change occurs in a state of an external space.

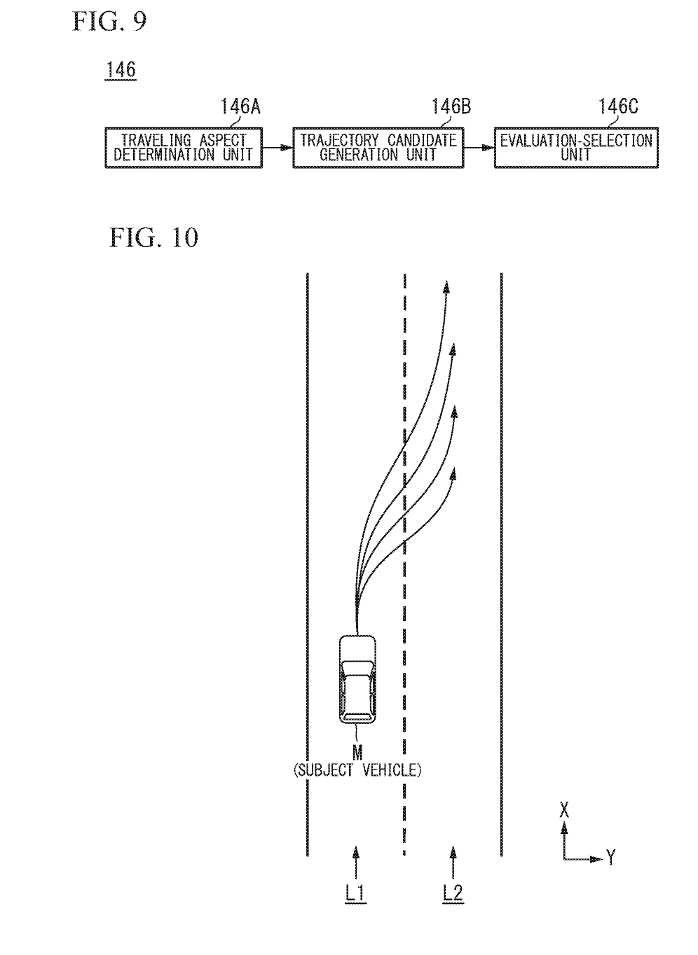

FIG. 9 is a diagram illustrating an example of a constitution of the trajectory generation unit 146. For example, the trajectory generation unit 146 includes a traveling aspect determination unit 146A, a trajectory candidate generation unit 146B, and an evaluation⋅selection unit 146C.

For example, when the lane keep event is executed, the traveling aspect determination unit 146A determines one of traveling aspects among constant speed traveling, following traveling, low speed following traveling, deceleration traveling, curve traveling, obstacle avoidance traveling, and the like. For example, in a case where other vehicles are not present in front of the subject vehicle M, the traveling aspect determination unit 146A determines a traveling aspect as the constant speed traveling. In addition, in a case where following the preceding vehicle is performed, the traveling aspect determination unit 146A determines the traveling aspect as the following traveling. In addition, in a congestion situation or the like, the traveling aspect determination unit 146A determines the traveling aspect as the low speed following traveling. In addition, in a case where a deceleration of the preceding vehicle is recognized by the external space recognition unit 142 or in a case where an event of stopping, parking, or the like is implemented, the traveling aspect determination unit 146A determines the traveling aspect as the deceleration traveling. In addition, in a case where it is recognized that the subject vehicle M reaches a curve road by the external space recognition unit 142, the traveling aspect determination unit 146A determines the traveling aspect as the curve traveling. In addition, in a case where an obstacle is recognized in front of the subject vehicle M by the external space recognition unit 142, the traveling aspect determination unit 146A determines the traveling aspect as the obstacle avoidance traveling.

The trajectory candidate generation unit 146B generates a candidate for the trajectory on the basis of the traveling aspect determined by the raveling aspect determination unit 146A. FIG. 10 is a diagram illustrating an example of the candidate for the trajectory generated by the trajectory candidate generation unit 146B. FIG. 10 shows a candidate for a trajectory generated in a case where the subject vehicle M changes the lane from a lane L1 to a lane L2.

For example, the trajectory candidate generation unit 146B determines a trajectory as shown in FIG. 10 as a collection of target positions (trajectory point K) to which a reference position (for example, a center of gravity or a rear wheel shaft center) of the subject vehicle reaches, at a predetermined time interval in the future.

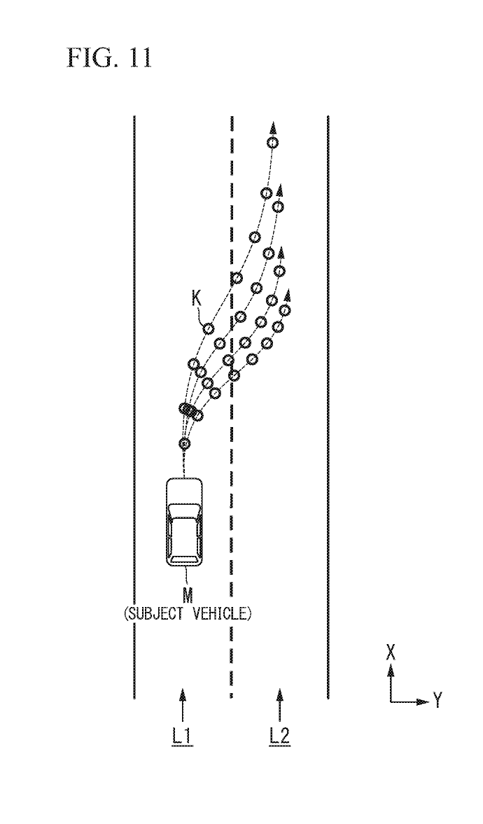

FIG. 11 is a diagram expressing the candidate for the trajectory generated by the trajectory candidate generation unit 146B by the trajectory point K. As a distance between the trajectory points K is wider, the speed of the subject vehicle M becomes faster, and as the distance between the trajectory points K is narrower, the speed of the subject vehicle M becomes slower. Therefore, in a case of performing the acceleration, the trajectory candidate generation unit 146B gradually widens the distance between the trajectory points K, and in a case of performing the deceleration, the trajectory candidate generation unit 146B gradually narrows the distance between the trajectory points K.

As described above, since the trajectory point K includes a speed component, the trajectory candidate generation unit 146B needs to give a target speed to each of the trajectory points K. The target speed is determined according to the traveling aspect determined by the traveling aspect determination unit 146A.

Here, a method of determining the target speed in a case where the lane change (including a branch) is performed will be described.

First, the trajectory candidate generation unit 146B sets a lane change target position (or a merge target position). The lane change target position is set as a relative position with respect to the surroundings vehicle and determines “which the lane changes between surroundings vehicles”. The trajectory candidate generation unit 146B focuses on three surroundings vehicles on the basis of the lane change target position and determines the target speed in a case where the lane change is performed.

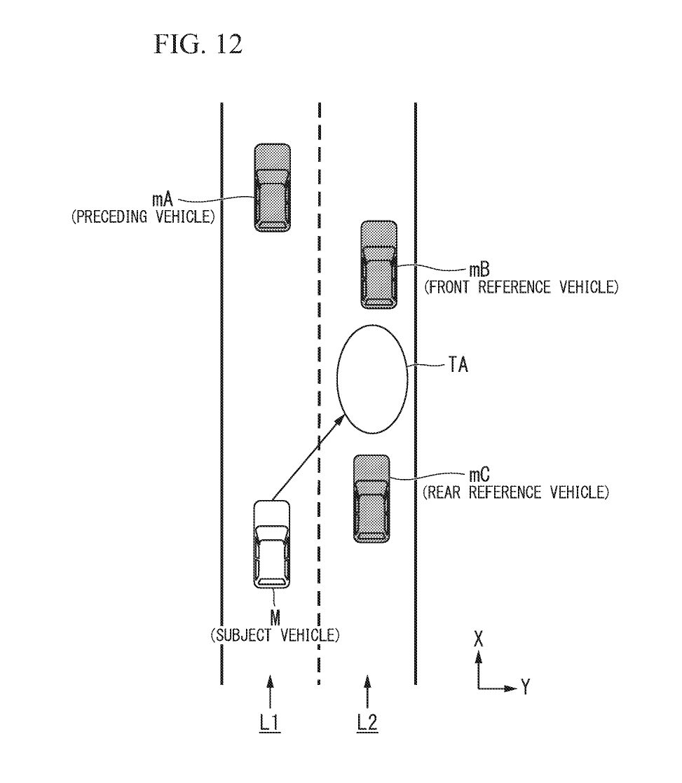

FIG. 12 is a diagram illustrating a lane change target position TA. In the drawing, L1 denotes the subject lane and L2 denotes an adjacent lane. Here, a surroundings vehicle that travels immediately before the subject vehicle M will be referred to as a preceding vehicle mA, a surroundings vehicle that travels immediately before the lane change target position TA will be referred to as a front reference vehicle mB, and a surroundings vehicle that travels immediately after the lane change target position TA will be referred to as a rear reference vehicle mC on the same lane as the subject vehicle M. The subject vehicle M needs to accelerate or decelerate in order to move to a side of the lane change target position TA, but it is necessary to avoid catching up with the preceding vehicle mA at this time. Therefore, the trajectory candidate generation unit 146B predicts a future state of the three surroundings vehicles and determines the target speed so as not to interfere with each surroundings vehicles.

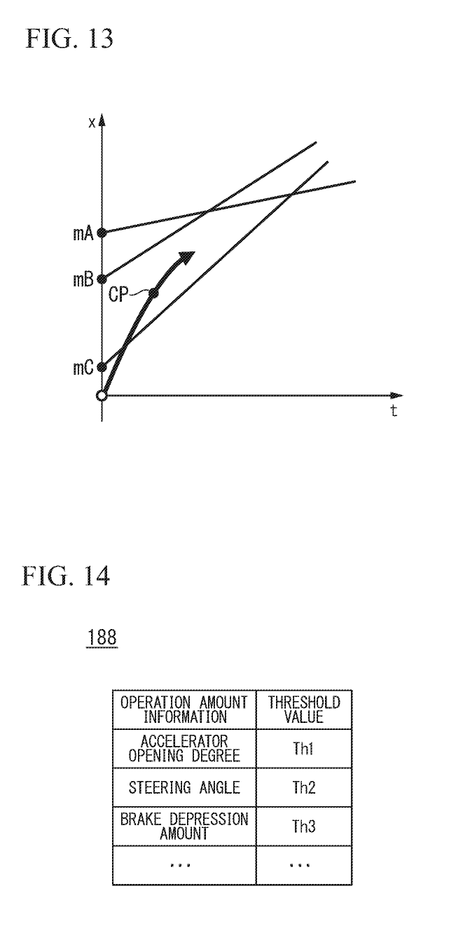

FIG. 13 is a diagram illustrating a speed generation model in a case where it is assumed that speeds of the three surroundings vehicles are constant. In the drawing, a straight line extending from mA, mB, and mC indicates a displacement in a traveling direction of a case where it is assumed that each surroundings vehicle travels at a constant speed. The subject vehicle M is required to be present between the front reference vehicle mB and the rear reference vehicle mC at a point CP where the lane change is completed and is required to be present behind the preceding vehicle mA before the subject vehicle M is present between the front reference vehicle mB and the rear reference vehicle mC. Under such restriction, the trajectory candidate generation unit 146B derives a plurality of time series patterns of the target speed until the lane change is completed. In addition, a plurality of trajectory candidates as shown in FIG. 10 described above are derived by applying the time series patterns of the target speed to a model such as a spline curve. It is noted that motion patterns of the three surroundings vehicles are not limited to the constant speed as shown in FIG. 13, but may be predicted on a premise of a constant acceleration and a constant jerk (jerk).

For example, the evaluation⋅selection unit 146C evaluates the candidate for the trajectory generated by the trajectory candidate generation unit 146B from two viewpoints of planning quality and safety and selects the trajectory to be output to the traveling control unit 160. For example, from the viewpoint of the planning quality, in a case where following to an already generated plan (for example, the action plan) is high and a total length of the trajectory is short, the trajectory is highly evaluated. For example, in a case where it is desired to perform the lane change to a right direction, a trajectory in which once the lane change is performed to a left direction and the subject vehicle is returned is lowly evaluated. From the viewpoint of the safety, for example, at each trajectory point, as a distance between the subject vehicle M and the object (the surroundings vehicle or the like) is long and the acceleration or deceleration speed or a change amount of the steering angle is small, the trajectory is highly evaluated.

The switch control unit 150 switches between the automated driving mode and the manual driving mode on the basis of the signal input from the automated driving changeover switch 87A. In addition, the switch control unit 150 performs control for switching from the automated driving mode to the manual driving mode on the basis of the operation for instructing the speed (one or both of the acceleration and the deceleration) or the steering with respect to the constitution of the driving operation system in the HMI 70.

For example, the switch control unit 150 compares the operation amount indicated by the signal input from the constitution of the driving operation system (for example, at least one of the traveling driving force output device 200, the steering device 210, and the brake device 220) in the HMI 70 with the threshold value (the override threshold value 188) of the operation amount stored in the storage unit 180. In addition, for example, the operation amount includes the magnitude of the operation force, the distance or the angle changed by the operation.

Here, for example, the operation amount obtained from the traveling driving force output device 200 is information related to the accelerator opening degree based on the operation of the vehicle occupant detected by the accelerator opening degree sensor 200B. In addition, for example, the operation amount obtained from the steering device 210 is information related to the steering angle based on the operation of the vehicle occupant detected by the steering angle sensor 210C. In addition, for example, the operation amount obtained from the brake device 220 is information related to the depression force based on the operation of the vehicle occupant detected by the depression force sensor 220B.

In a case where the above-described operation amount is greater than the threshold value, the switch control unit 150 performs the override control for switching from the automated driving mode to the manual driving mode. For example, in a case where a value obtained by subtracting the threshold value from the above-described operation amount is less than 0, a case where a value (a rate, a ratio) obtained by dividing the operation amount by the threshold value is greater than 1, or the like, the switch control unit 150 performs the override control. In addition, in a case where a state in which the operation amount is greater than the threshold value continues for a predetermined time or more, the switch control unit 150 may perform the override control.

Here, FIG. 14 is a diagram illustrating an example of the override threshold value 188. In the example of FIG. 14, for example, as items of the override threshold value 188, “operation amount information”, the “threshold value”, and the like are provided, but the item of the override threshold value 188 is not limited thereto. For example, in the present embodiment, a threshold value other than the override threshold value may be set and comparison with the set value may be performed.

For example, the “operation amount information” is information related to an operation amount generated in the operation reception unit as a result of the operation of the operation reception unit by the vehicle occupant. As an example of the operation reception unit, there is at least one of the accelerator pedal 200A, the steering wheel 210A, and the brake pedal 220A. In addition, for example, as an example of the operation amount information, there is the accelerator opening degree with respect to the accelerator pedal 200A, the steering angle with respect to the steering wheel 210A, and the brake depression amount with respect to the brake pedal 220A, and the like, but the example of the operation amount information is not limited thereto. In the example of FIG. 14, threshold values Th1 to Th3 are set with respect to pieces of the operation amount information described above, respectively.

The switch control unit 150 compares the operation amount corresponding to the accelerator opening degree, the steering angle, and the brake depression amount actually acquired by the driving operation of the vehicle occupant with the threshold value of the operation amount stored in the override threshold value 188, and performs the above-described override control on the basis of a comparison result.

In addition, the switch control unit 150 outputs information indicating the comparison result to the HMI control unit 170. For example, as the information indicating the comparison result, there are the information related to the operation amount, the information related to the threshold value of the operation amount, the information related to the comparison result described above, and the like, but the information indicating the comparison result is not limited thereto. In addition, in a case where the operation for the constitution of the driving operation system in the HMI 70 is not detected for a predetermined time after switching to the manual driving mode by the override, the switch control unit 150 may return the mode to the automated driving mode.

The traveling control unit 160 automatically performs at least one of the speed control and the steering control of the subject vehicle M on the basis of a schedule determined by the action plan generation unit 144 and the trajectory generation unit 146 described above. For example, the traveling control unit 160 controls the traveling driving force output device 200, the steering device 210, and the brake device 220 so that the subject vehicle M passes through the (scheduled) traveling trajectory (trajectory information) generated by the trajectory generation unit 146 at the scheduled time.

The HMI control unit 170 outputs information indicating the relationship between the operation amount related to the acceleration control and/or the steering control from the vehicle occupant of the subject vehicle M received from the driving operation system of the HMI 70 and the threshold value of the operation amount at which the control for switching from the automated driving to the manual driving is implemented to the output unit or the like.

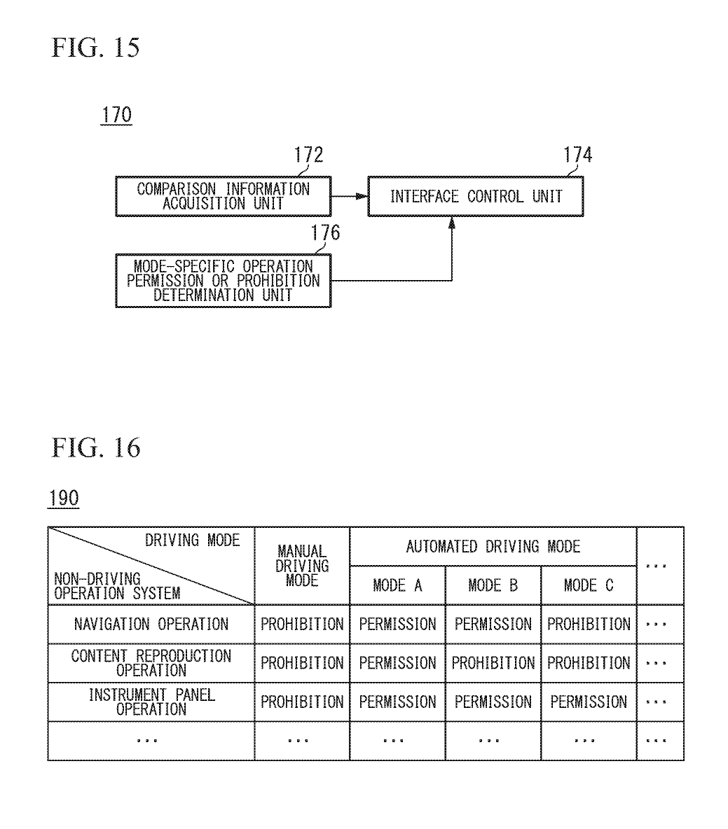

FIG. 15 is a diagram illustrating a functional constitution example of the HMI control unit 170. In the example of FIG. 15, the HMI control unit 170 includes a comparison information acquisition unit 172, an interface control unit 174, and a mode-specific operation permission or prohibition determination unit 176.

The comparison information acquisition unit 172 acquires the information indicating the relationship between the operation amount related to the acceleration control and/or the steering control from the vehicle occupant of the subject vehicle M received from the driving operation system (for example, the traveling driving force output device 200, the steering device 210, and the brake device 220) of the HMI 70 and the threshold value of the operation amount at which the control for switching from the automated driving to the manual driving is implemented from the above-described traveling control unit 150. For example, the comparison information acquisition unit 172 acquires information indicating a result of the comparison between the operation amount and the threshold value as the information indicating the relationship between the operation amount and the threshold value described above.

The interface control unit 174 outputs the information acquired by the comparison information acquisition unit 172 from the output unit and notifies the vehicle occupant of the subject vehicle M of the information acquired by the comparison information acquisition unit 172. An example of the output unit includes at least one of the navigation device 50, the display device 82, the speaker 83, and the like.

It is noted that the interface control unit 174 may cause the mode-specific operation permission or prohibition determination unit 176 to output the information indicating the relationship between the operation amount and the threshold value of the operation amount described above to the output unit that is able to be operated by the vehicle occupant by the driving mode. As described above, it is possible to enable the vehicle occupant more surely to grasp the operation situation, by displaying the information related to the operation situation on the output unit with a high possibility that the vehicle occupant is watching.

In a case where the automated driving control unit 120 notifies the information on the mode of the automated driving, the mode-specific operation permission or prohibition determination unit 176 determines an operation permission or prohibition of the HMI 70 (the non-driving operation system) according to the type of the mode of the automated driving with reference to mode-specific operation permission or prohibition information 190.

FIG. 16 is a diagram illustrating an example of the mode-specific operation permission or prohibition information 190. The mode-specific operation permission or prohibition information 190 shown in FIG. 16 has the “manual driving mode” and the “automated driving mode” as items of the driving mode. In addition, the mode-specific operation permission or prohibition information 190 has the “mode A”, the “mode B”, the “mode C”, and the like described above as the “automated driving mode”. In addition, the mode-specific operation permission or prohibition information 190 has a “navigation operation” that is an operation for the navigation device 50, a “content reproduction operation” that is an operation for the content reproduction device 85, an “instrument panel operation” that is an operation for the display device 82, and the like as items of the non-driving operation system. In the example of the mode-specific operation permission or prohibition information 190 shown in FIG. 16, permission or prohibition of the operation of the vehicle occupant for the non-driving operation system is set for each of the above-described driving modes, but an interface device (the display unit or the like) of a target is not limited thereto.

The mode-specific operation permission or prohibition determination unit 176 determines an output device of which use is permitted and an output device of which the user is not permitted among a plurality of output devices included in the output unit, by referring to the mode-specific operation permission or prohibition information 190 on the basis of the information of the mode acquired from the automated driving control unit 120. In addition, the mode-specific operation permission or prohibition determination unit 176 outputs a determination result to the interface control unit 174. Therefore, the interface control unit 174 controls whether or not to permit the reception of the operation from the vehicle occupant for the HMI 70 or the like of the non-driving operation system.

For example, in a case where the driving mode executed by the vehicle control system 100 is the manual driving mode, the vehicle occupant operates the driving operation system (for example, the accelerator pedal 200A, the steering wheel 210A, the brake pedal 220A, and the like.) of the HMI 70. In such a case, in order to prevent distraction of attention (driver distraction) due to a behavior (for example, the operation of the non-driving operation system of the HMI 70 or the like) other than the driving of the vehicle occupant, the interface control unit 174 performs control so that the operation for a part or all of the non-driving operation system of the HMI 70 is not received.

In addition, in a case where the driving mode executed by the vehicle control system 100 is the mode B, the mode C, or the like of the automated driving mode, the vehicle occupant is obligated to monitor the surroundings of the subject vehicle M. Therefore, also in such a case, the interface control unit 174 performs control so that the operation for a part or all of the non-driving operation of the HMI 70 is not received in order to prevent the driver distraction.

In addition, in a case where the driving mode is the mode A of the automated driving, the interface control unit 174 relaxes a regulation of the driver distraction and performs control for receiving the operation of the vehicle occupant for the non-driving operation system of which the operation has not received.

For example, the interface control unit 174 causes the display device 82 that is an example of the plurality of output devices included in the output unit to display an image, causes the speaker 83 to output a sound, or causes the content reproduction device 85 to reproduce a content from a DVD or the like. In addition, for example, the content reproduced by the content reproduction device 85 may include various types of contents related to amusement and entertainment of a television program or the like in addition to the content stored in the DVD or the like. In addition, the “content reproduction operation” shown in FIG. 16 may mean a content operation related to such amusement and entertainment.

In the mode-specific operation permission or prohibition information 190 shown in FIG. 16, the “instrument panel operation” is also able to be operated in the mode C. In addition, in this case, for example, the display device 82 corresponding to the instrument panel is the display positioned on the front side of the vehicle occupant performing the driving of the subject vehicle M. In a case where a mode of which the degree of the automated driving is the lowest is executed among the automated driving modes (the mode A to mode C), the display device 82 is able to receive the operation of the vehicle occupant. Therefore, for example, in a case where the automated driving by the mode C is executed, the interface control unit 174 causes the display device 82 to output the information indicating the relationship between the operation amount and the threshold value.

As described above, the interface control unit 174 is able to select the output device that outputs the information indicating the relationship between the operation amount and the threshold value according to the driving mode and cause the selected output device to output the above-described information. Therefore, for example, the interface control unit 174 is able to cause the output device having a high possibility that the vehicle occupant is watching to display the information.

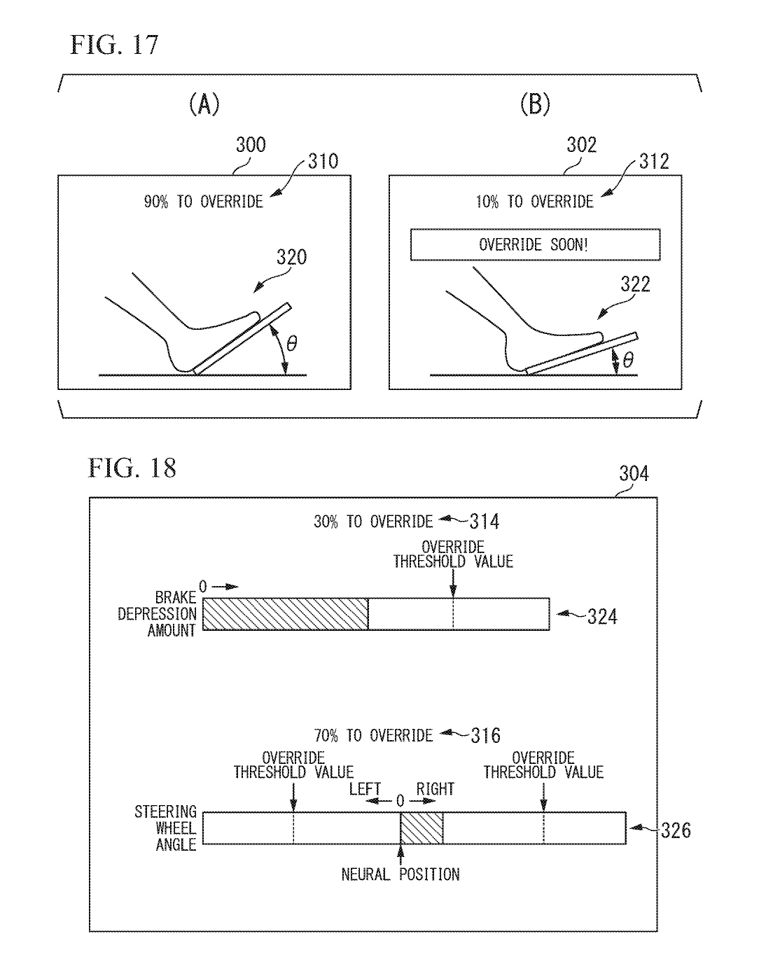

FIG. 17 is a diagram illustrating a first example in which the information indicating the relationship between the operation amount and the threshold value is output. In the example of FIG. 17, for example, an example in which the information is displayed on a screen of the display device 82 is shown, but the information may be displayed on another output unit such as the navigation device 50.

In the example of FIG. 17(A), the ratio of the depression force of the brake pedal 220A until the override control is performed is displayed as the information indicating the result of the comparison between the operation amount and the threshold value on a screen 300 of the display device 82 by character information 310. As an example of the character information 310, as shown in FIG. 17(A), there is “90% to override” or the like, but is not limited thereto. For example, the character information 310 may various messages such as “current depression amount 50” and “depression angle until switching to manual driving is 12°”. In addition, in addition to the character information 310 described above, the interface control unit 174 may display an image 320 in which a foot is placed on the brake pedal 220A so that the vehicle occupant of the subject vehicle can visually understand immediately. In this case, as shown in FIG. 17(A), it is preferable to display the image 320 at an angle θ corresponding to the depression amount (the rate, the ratio). Therefore, it is possible to more clearly notify the vehicle occupant of the operation situation for the HMI 70.

In addition, for example, in a case where a difference obtained by subtracting the operation amount from the threshold value is within a predetermined value, the interface control unit 174 may cause the output unit to output predetermined information (for example, a warning or the like). In this case, for example, as shown in FIG. 17(B), the interface control unit 174 outputs warning information such as “override soon!” in addition to character information 312 such as “10% to override” on the screen 302. In addition, in a case where an image 322 corresponding to the operation content is displayed on the screen 302, the interface control unit 174 is able to visually transfer the fact that the brake pedal 220A is being pressed by reducing the angle θ and displaying the angle θ as shown in FIG. 17(B).

In addition, in the example described above, although the brake pedal has been described, in the same manner, the operation state of the accelerator pedal 200A or the steering wheel 210A may be displayed by the character information 310 or the image 320. In addition, in addition to the character or the image, sound information corresponding to the character information 310 and 312 may be output from the output unit such as the speaker 83.

FIG. 18 is a diagram illustrating a second example in which the information indicating the relationship between the operation amount and the threshold value is output. In the second example, character information 314 and an image 324 related to the brake depression amount and character information 316 and an image 326 related to the steering angle are displayed on the screen 304 of the display unit such as the display device 82. For example, in a case where the vehicle occupant operates a plurality of operation elements, information on each operation content is displayed on the screen 304. Conversely, as shown in FIG. 18, an operation element (for example, the accelerator pedal 200A) that is not operated by the vehicle occupant may not be displayed.

In the second example, the interface control unit 174 displays the override threshold value (the threshold value of the operation amount at which the control for switching from the automated driving to the manual driving is implemented) and a current operation amount (a diagonal line portion shown in FIG. 18) in the images 324 and 326. In addition, in the example of FIG. 18, a state (a neural position) in which the brake pedal 220A and the steering wheel 210A is fixed with respect to the automated driving is set to 0 and the operation amount from the state is displayed, but the present invention is not limited thereto, and in a case where the brake pedal 220A, the steering wheel 210A, or the like is changed by the automated driving, a changing position may be set as a reference (0). The vehicle occupant can clearly grasp how much further it takes to switch to the manual driving by the override by watching the character information 314 and 316 and the images 324 and 326. In addition, in the present embodiment, information that is a combination of a part or all of the first example and the second example described above may be output.

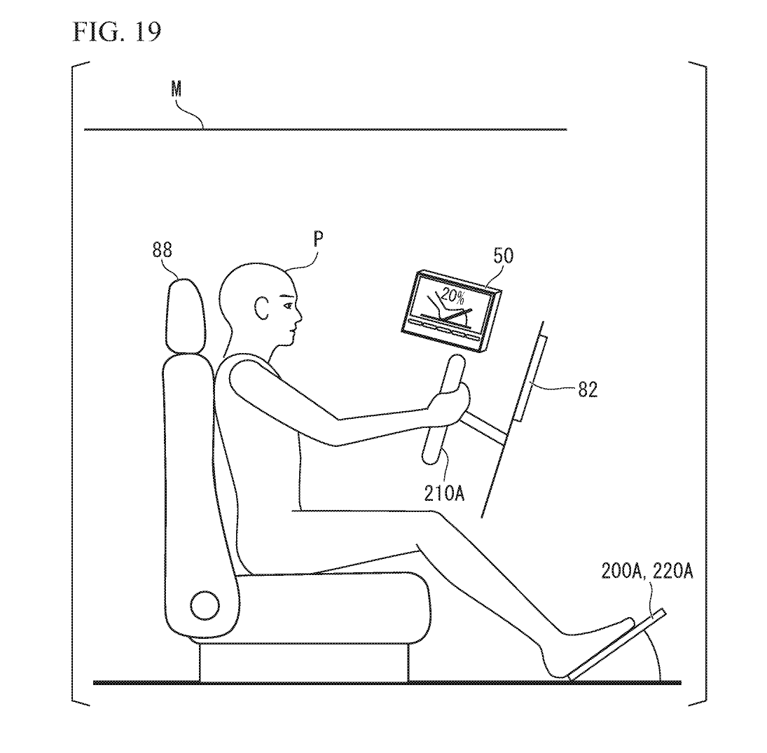

FIG. 19 is a diagram for explaining the operation content of the vehicle occupant in the subject vehicle M. In an example of FIG. 19, a state in which the vehicle occupant P of the subject vehicle M is seated on the seat 88 is shown and the navigation device 50 and the display device 82 are shown as an example of the output unit provided in the subject vehicle M. It is noted that the display device 82 indicates a display provided on the instrument panel. In addition, in the example of FIG. 19, as an example of the driving operation system of the HMI 70, the accelerator pedal 200A, the brake pedal 220A, and the steering wheel 210A are shown.

In addition, in the present embodiment, during the automated driving such as the mode A, the accelerator pedal 200A and the brake pedal 220A are able to be used as the footrest and the steering wheel 210A is able to be used as the armrest. In addition, since the operation for each of the operation elements is displayed on the output unit such as the navigation device 50 by the HMI control unit 170, the vehicle occupant can safely touch the operation element with a hand or put a foot on the operation element. In addition, the vehicle occupant P can easily grasp how much pressure (load) is applied to shift to the manual driving by the override.

<Processing Flow>

Hereinafter, a flow of the processing by the vehicle control system 100 according to the present embodiment will be described. In addition, in the following description, among the various processes in the vehicle control system 100, the switch control processing in the switch control unit 150 and the display control processing on the output unit by the HMI control unit 170 will be mainly described.

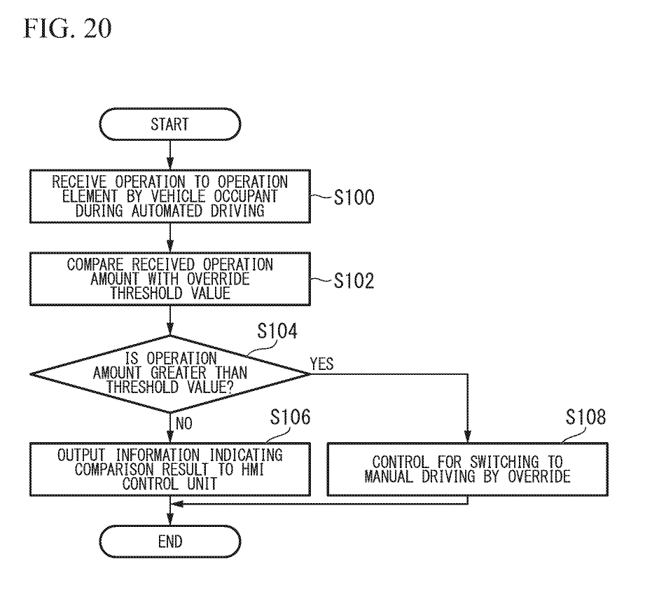

FIG. 20 is a flowchart illustrating an example of the switch control processing. In the example of the FIG. 20, the switch control unit 150 receives the operation to the operation element by the vehicle occupant during the automated driving (step S100). The switch control unit 150 compares the operation amount by the received operation with the override threshold value 188 that is set in advance (step S102) and determines whether or not the operation amount is greater than the threshold value (step S104). In addition, in the processing of step S104, it may be determined whether or not the state in which the operation amount is greater than the threshold value continues for a reference time or more.

In a case where the operation amount is not greater than the threshold value, the switch control unit 150 outputs the information indicating the comparison result to the HMI control unit 170 (step S106). In addition, in a case where the operation amount is greater than the threshold value, the switch control unit 150 performs the control for switching to the manual driving by the override (step S108).

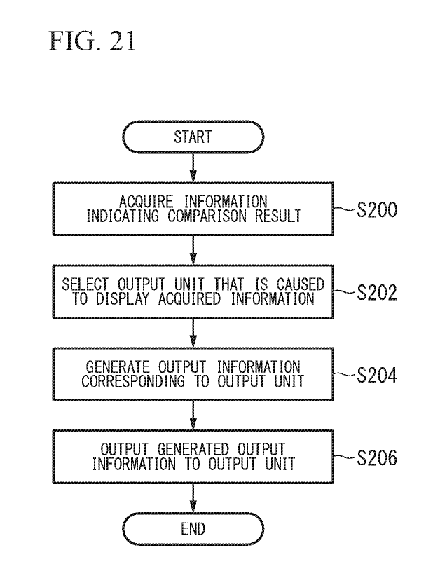

FIG. 21 is a flowchart illustrating an example of the display control processing. In the example of FIG. 21, the comparison information acquisition unit 172 acquires the information indicating the result of the comparison described above by the switch control unit 150 (step S200). Next, the interface control unit 174 selects the output unit that is able to be operated according to the driving mode determined by the mode-specific operation permission or prohibition determination unit 176 or the like (step S202). In addition, in the processing of step S202, an output unit that is set in advance may be selected.

Next, interface control unit 174 generates the output information corresponding to the output unit (step S204). For example, in a case where the output unit is the navigation device 50 or the display device 82, the character information or the image corresponding to the information indicating the comparison result is generated as described above. In addition, in a case where the output unit is the speaker 83, the sound information corresponding to the information indicating the comparison result is generated. Next, the interface control unit 174 outputs the generated output information to the selected output unit (step S206).

According to the embodiment described above, the HMI control unit 170 is able to notify of the information related to the degree of the operation to the driving operation system until the driving mode is switched from the automated driving to the manual driving by the override by causing the output unit of the HMI 70 to output the information indicating the relationship between the operation amount related to the speed control or the steering control from the vehicle occupant of the subject vehicle M received by the HMI 70 and the threshold value of the operation amount at which the control for switching from the automated driving to the manual driving is implemented. Therefore, it is possible to give a sense of security to the vehicle occupant of the subject vehicle M.

Although aspects for carrying out the present invention have been described above using the embodiments, the present invention is not limited to these embodiments at all, and various modifications and substitutions may be added without departing from the spirit of the present invention.

### INDUSTRIAL APPLICABILITY

The present invention can be utilized in an automobile manufacturing industry.

### REFERENCE SIGNS LIST

20 Finder
30 Radar
40 Camera
DD Detection device
50 Navigation device
60 Vehicle sensor
70 HMI
100 Vehicle control system
110 Target lane determination unit
120 Automated driving control unit
130 Automated driving mode control unit
140 Subject vehicle position recognition unit
142 External space recognition unit
144 Action plan generation unit
146 Trajectory generation unit
146A Traveling aspect determination unit
146B Trajectory candidate generation unit
146C Evaluation⋅selection unit
150 Switch control unit
160 Traveling control unit
170 HMI control unit
172 Comparison information acquisition unit
174 Interface control unit
176 Mode-specific operation permission or prohibition determination unit
180 Storage unit
200 Traveling driving force output device
210 Steering device
220 Brake device
M Subject vehicle

1. A vehicle control system comprising:
an operation reception unit configured to receive an operation of an occupant of a vehicle;
an automated driving control unit configured to automatically perform at least one of speed control and steering control of the vehicle and switch from automated driving to manual driving on the basis of the operation received by the operation reception unit;
an output unit configured to output information; and
an interface control unit configured to cause the output unit to output information indicating a relationship between an operation amount related to the speed control or the steering control from the occupant of the vehicle received by the operation reception unit and a threshold value of an operation amount at which control for switching from the automated driving to the manual driving is implemented by the automated driving control unit.

2. The vehicle control system of claim 1, wherein the interface control unit causes the output unit to output information indicating a result of a comparison between the operation amount and the threshold value.

3. The vehicle control system of claim 1, wherein, in a case where a difference obtained by subtracting the operation amount from the threshold value is within a predetermined value, the interface control unit causes the output unit to output predetermined information.

4. The vehicle control system of claim 1, wherein the interface control unit causes the output unit to output the threshold value of the operation amount at which the control for switching from the automated driving to the manual driving of the vehicle is implemented.

5. The vehicle control system of claim 1, wherein the automated driving control unit performs the automated driving in a plurality of modes having different degrees of the automated driving,
the output unit includes a plurality of output devices, and
the interface control unit selects an output device that outputs the information according to the mode.

6. The vehicle control system of claim 1, wherein the operation reception unit is at least one of respective operation elements of an accelerator pedal, a brake pedal, and a steering wheel of the vehicle.

7. A vehicle control method that causes an in-vehicle computer to:
receive an operation of an occupant of a vehicle by an operation reception unit;
automatically perform at least one of speed control and steering control of the vehicle and switch from automated driving to manual driving on the basis of the operation received by the operation reception unit; and
cause an output unit to output information indicating a relationship between an operation amount related to the speed control or the steering control from the occupant of the vehicle received by the operation reception unit and a threshold value of an operation amount at which control for switching from the automated driving to the manual driving is implemented.

8. A vehicle control program that causes an in-vehicle computer to:
receive an operation of an occupant of a vehicle by an operation reception unit;
automatically perform at least one of speed control and steering control of the vehicle and switch from automated driving to manual driving on the basis of the operation received by the operation reception unit; and
cause an output unit to output information indicating a relationship between an operation amount related to the speed control or the steering control from the occupant of the vehicle received by the operation reception unit and a threshold value of an operation amount at which control for switching from the automated driving to the manual driving is implemented.
